(19) United States
(12) Patent Application Publication
(10) Pub. No.: US 2025/0327484 A1
(43) Pub. Date: Oct. 23, 2025

(54) TRIPOD CONSTANT VELOCITY JOINT

(71) Applicant: ERAE AMS CO., LTD., Daegu (KR)

(72) Inventors: Dal Soo JANG, Daegu (KR); Kwang Jin LEE, Daegu (KR)

(73) Assignee: ERAE AMS CO., LTD., Daegu (KR)

(21) Appl. No.: 18/281,042

(22) PCT Filed: Feb. 28, 2022
(86) PCT No.: PCT/KR2022/002853

§ 371 Date: Feb. 29, 2024

(30) Foreign Application Priority Data
Mar. 10, 2021 (KR) 10-2021-0031593

(51) Int. Cl. F16D 3/205; F16C 19/18

(52) U.S. Cl. CPC F16D 3/2055; F16C 19/18

(57) ABSTRACT

A tripod constant velocity joint according to an embodiment of the present invention includes: a housing having a tubular shape that forms three track grooves arranged along a circumferential direction; a spider having a hub placed inside the housing and three journals respectively extending radially outward from the hub and respectively arranged in the track grooves; and three bearing units respectively engaged to the journals. Each of the bearing units comprises a track race that is arranged in the track groove in a state of being tiltably engaged to the journal and a first and a second ball array that are disposed between a peripheral surface of the track race and power transmission surfaces facing each other in a circumferential direction to form the track grooves and respectively comprise a plurality of balls. The first and second ball arrays are arranged at different positions along a length direction of the journal.

### TECHNICAL FIELD

The present invention relates to a tripod constant velocity joint used for transmitting driving power in a vehicle.

### BACKGROUND ART

A constant velocity joint is used to transmit a driving force generated by a vehicle's driving device, such as an engine, to a wheel. A tripod constant velocity joint is a type of constant velocity joint that allows axial displacement and is classified as a plunging type. Such a tripod constant velocity joint is primarily used as an inboard joint of a vehicle's drive shaft, and is required to have features of reduced internal friction for improved NVH (Noise, Vibration, and Harshness) performance of a vehicle and compact size to be fitted within a limited space inside a vehicle.

A tripod constant velocity joint generally comprises of a housing having three grooves, an inner joint member (also referred to as a spider) having three journals protruding radially, and three roller units, each engaged to a journal. Typically, the roller unit comprises an outer roller and an inner roller in a shape of a ring, and a needle bearing disposed between the outer and inner rollers. This type of roller unit has inherent limitations in terms of a reduction of an internal friction and a size reduction.
Prior art document: U.S. Pat. No. 8,550,924 (2013 Oct. 8)

### DETAILED DESCRIPTION OF THE INVENTION

### Technical Problem

An object of the present invention is to provide a tripod constant velocity joint that has a small size and a reduced internal friction.

### Technical Solutions

A tripod constant velocity joint according to an embodiment of the present invention includes: a housing having a tubular shape that forms three track grooves arranged along a circumferential direction; a spider having a hub placed inside the housing and three journals respectively extending radially outward from the hub and respectively arranged in the track grooves; and three bearing units respectively engaged to the journals. Each of the bearing units comprises a track race that is arranged in the track groove in a state of being tiltably engaged to the journal and a first and a second ball array that are disposed between a peripheral surface of the track race and power transmission surfaces facing each other in a circumferential direction to form the track grooves and respectively comprise a plurality of balls. The first and second ball arrays are arranged at different positions along a length direction of the journal.

The track race may include a first and a second inner ball groove configured to partially accommodate the first and second ball arrays, respectively. The first and second inner ball grooves may respectively form a ball circulation path that allows the balls of the first and second ball arrays to circulate along a periphery of the track race.

Heights of openings of the first and second inner ball grooves may be smaller than a diameter of the ball.

The first and second inner ball grooves may include a straight section provided on a portion facing the power transmission surface, and a curved section connecting the linear section. The power transmission surface of the housing may be provided with a first and a second outer ball grooves formed at positions corresponding to the straight sections of the first and second inner ball grooves.

A height of the opening of the curved section of the first and second inner ball grooves may be smaller than a height of an opening of the straight section.

The track race may include a first and a second inner ball groove configured to partially accommodate the first and second ball arrays respectively. The housing may include a first and second outer ball grooves, respectively formed on the power transfer surface at positions corresponding to the first and second inner ball grooves, to accommodate parts of the balls of the first and second ball arrays that are exposed outside the first and second inner ball grooves.

The balls of the first and second ball arrays may be configured to contact at one or more points with the first and second inner ball grooves and the first and second outer ball grooves, respectively.

A clearance between a peripheral surface of the track race and the power transfer surface may be greater than a clearance between the balls of the first and second ball arrays and the first and second outer ball grooves.

The bearing unit may further include a retainer configured to surround the track race and accommodates the first and second ball arrays.

The retainer may be provided with a first and a second window that are respectively formed on a part facing the power transmission surface, to expose outer part of a portion of balls of the first and second ball arrays.

A height of the first and second windows may be smaller than a diameter of the balls of the first and second ball arrays.

The first and second inner grooves may extend along a peripheral surface of the track race to form circulation paths in which the balls of the first and second ball arrays can circulate. The retainer may further include a third and a fourth window formed at portions perpendicular to parts facing the power transmission surface, to expose outer parts of a portion of the balls of the first and second ball arrays.

Heights of the third and fourth windows may be smaller than heights of the first and second windows.

The track race may include a first and a second inner ball groove formed to partially accommodate the first and second ball arrays, respectively. The retainer may have a first and a second window that are respectively formed on a portion facing the power transfer surface to allow outer portions of a portion of the balls of the first and second ball arrays to be exposed. The housing may include a first and a second outer ball grooves that are respectively formed on the power transfer surface at positions corresponding to the first and second inner ball grooves, to accommodate the exposed portions of the balls of the first and second ball arrays.

A clearance between the retainer and the power transfer surface may be greater than a clearance between the balls of the first and second ball arrays and the first and second outer ball grooves.

A tripod constant velocity joint according to another embodiment of the present invention includes: a housing having a tubular shape that forms three track grooves arranged along a circumferential direction; a spider having a hub placed inside the housing and three journals respectively extending radially outward from the hub and respectively arranged in the track grooves; and three bearing units respectively engaged to the journals. Each of the bearing units comprises: a track race that is arranged in the track groove in a state of being tiltably engaged to the journal; and a first and a second ball array that are disposed between a peripheral surface of the track race and power transmission surfaces facing each other in a circumferential direction to form the track grooves and respectively comprise a plurality of balls. The first and second ball arrays are arranged in different positions along a longitudinal direction of the journal, and the track race comprises a first and a second inner ball groove that are respectively configured to partially accommodate the first and second ball arrays. The housing comprises a first and a second outer ball groove that are respectively formed on the power transmission surface to correspond to the first and second inner ball grooves. Heights of openings of the first and second inner grooves are smaller than a diameter of the balls of the first and second ball arrays.

A clearance between a peripheral surface of the track race and the power transfer surface may be greater than a clearance between the balls of the first and second ball arrays and the first and second outer ball grooves.

The first and second inner ball grooves respectively comprise a pair of straight sections respectively facing the power transfer surfaces that face each other and curved sections connecting the pair of straight sections. A height of openings of the first and second inner ball grooves in the curved sections may be smaller than a heigh of openings of the first and second inner ball grooves in the straight section.

The balls of the first and second ball arrays may be configured to contact at one or more points with the first and second inner ball grooves and the first and second outer ball grooves, respectively.

A tripod constant velocity joint according to another embodiment of the present invention includes: a housing having a tubular shape that forms three track grooves arranged along a circumferential direction; a spider having a hub placed inside the housing and three journals respectively extending radially outward from the hub and respectively arranged in the track grooves; and three bearing units respectively engaged to the journals. Each of the bearing units comprises: a track race that is arranged in the track groove in a state of being tiltably engaged to the journal; a first and a second ball array that are disposed between a peripheral surface of the track race and power transmission surfaces facing each other in a circumferential direction to form the track grooves and respectively comprise a plurality of balls; and a retainer configured to surround the track race and accommodates the first and second ball arrays. The first and second ball arrays are arranged at different positions along a longitudinal direction of the journal, and the track race comprises a first and a second inner ball groove that are configured to partially accommodate the first and second ball arrays, respectively. The housing comprises a first and a second outer ball groove that are respectively formed on the power transmission surface to correspond to the first and second inner ball grooves. The retainer is provided with a first and a second window that are respectively formed on a part facing the power transmission surface to allow outer portions of a portion of the balls of the first and second ball arrays to be exposed, and heights of the first and second windows are smaller than a diameter of the balls of the first and second ball arrays.

A clearance between the retainer and the power transfer surface may be greater than a clearance between the balls of the first and second ball arrays and the first and second outer ball grooves.

The first and second inner grooves may extend along a peripheral surface of the track race to form circulation paths in which the balls of the first and second ball arrays can circulate. The retainer may further include a third and a fourth window formed at portions perpendicular to parts facing the power transmission surface, to expose outer parts of a portion of the balls of the first and second ball arrays. Heights of the third and fourth windows may be smaller than heights of the first and second windows.

The balls of the first and second ball arrays may be configured to contact at one or more points with the first and second inner ball grooves and the first and second outer ball grooves, respectively.

### Effect of the Invention

According to this invention, by equipping a bearing unit with a plurality of ball arrays positioned at different radial locations on a journal, it is possible to achieve a compact size while reducing internal friction.

### BRIEF DESCRIPTION OF DRAWINGS

FIG. 1 is a perspective view of a tripod constant velocity joint according to an embodiment of the invention.

FIG. 2 is a cross-sectional view taken along line II-II of FIG. 1.

FIG. 3 is a cross-sectional view taken along line III-III of FIG. 1.

FIG. 4 is an exploded perspective view of a tripod constant velocity joint according to an embodiment of the invention.

FIG. 5 is a front view of a tripod constant velocity joint according to an embodiment of the invention.

FIG. 6 is an enlarged view of a portion of FIG. 2.

FIG. 7 illustrates a sectional view taken along a plurality of balls of a bearing unit of a tripod constant velocity joint according to an embodiment of the invention.

FIG. 8 is an enlarged view of a portion of FIG. 6.

FIG. 9 is an enlarged view of a portion of FIG. 8, illustrating a diameter d1 of a ball and an entrance height d2 of a track race.

FIG. 10 is a perspective view of a track race of a tripod constant velocity joint according to an embodiment of the invention.

FIG. 11 is an enlarged view of a portion of FIG. 8, illustrating a clearance c1 between a ball and a ball groove of a housing, and a clearance c2 between a track race and an operative surface of a housing.

FIG. 12 is a perspective view of a tripod constant velocity joint according to another embodiment of the present invention.

FIG. 13 is a cross-sectional view taken along a line XIII-XIII of FIG. 12.

FIG. 14 is an exploded perspective view of a tripod constant velocity joint according to another embodiment of the present invention.

FIG. 15 is a perspective view of an assembled state of a track race and a retainer of a tripod constant velocity joint according to another embodiment of the present invention.

FIG. 16 is an enlarged view of a portion of FIG. 13, illustrating a diameter d3 of a ball and an entrance height d4 of a retainer.

FIG. 17 is an enlarged view of a portion of FIG. 13, illustrating a clearance c3 between a ball and a ball groove of a housing, and a clearance c4 between a retainer and an operative surface of a housing.

### EMBODIMENTS FOR CARRYING OUT THE INVENTION

Hereinafter, embodiments of the present invention will be described in detail with reference to the attached drawings.

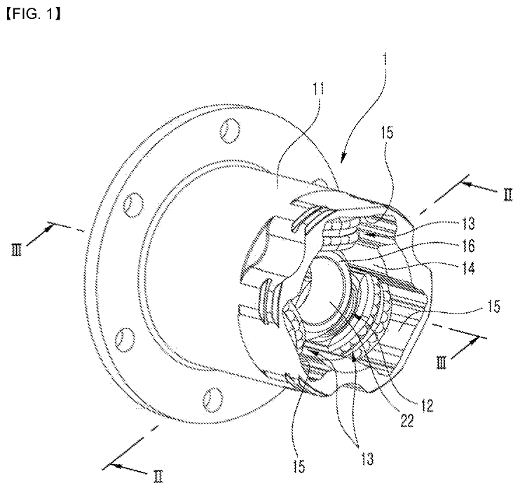

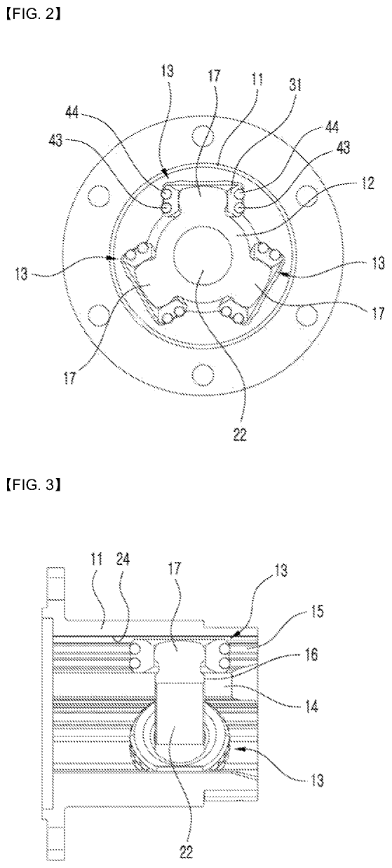

Referring to FIGS. 1 and 2, a tripod constant velocity joint 1 comprises a housing 11, a spider 12, and a bearing unit 13. The housing 11 and the spider 12 may be configured to be respectively connected to power transmission elements, for example, to a power transmission shaft. The bearing unit 13 is positioned between the housing 11 and the spider 12 to serve a role of power transmission medium and bearing functions.

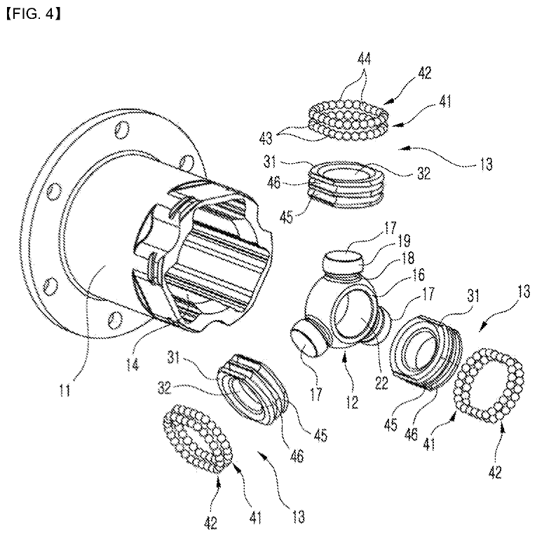

The housing 11 may have a tubular shape that is open on one side in an axial direction. Referring to FIGS. 1 and 3, the housing 11 forms an approximately cylindrical central cavity 14 extending in the axial direction and three track grooves 15 that are evenly spaced in a circumferential direction around the outer circumference of the central cavity 14 and extend parallel to the axial direction.

The spider 12 is positioned inside the housing 11. Referring to FIGS. 1 and 2, the spider 12 comprises a hub 16, and three journals 17 that protrude radially outward from an outer surface of the hub 16. The hub 16 is placed within the central cavity 14 of the housing 11, and the three journals 17 extend radially outward from the outer surface of the hub 16. The three journals 17 are evenly spaced in a circumferential direction around the outer surface of the hub 16 and can each be positioned within the track grooves 15 of the housing 11. The spider 12 is configured to move axially within the housing 11 and can tilt to allow angular displacement relative to the housing 11.

The power transmission shaft (not shown) can be connected to the hub 16 to rotate therewith. For example, the power transmission shaft can be inserted into a through hole 22 formed in the hub 16 and can be coupled thereto using a spline method.

The three bearing units 13 are each engaged to the three journals 17. Referring to FIGS. 2 and 3, the bearing unit 13 is positioned in the track groove 15 of the housing 11 while being engaged to the journal 17. The bearing unit 13 serves as a bearing between the housing 11 and the spider 12 and mediates power transmission. The bearing unit 13 engaged to the journal 17 is designed to move within the track groove 15 longitudinally, i.e., in a direction parallel to the axial direction of the housing 11. The movement of the bearing unit 13 within the track groove 15 allows for relative translational motion between the housing 11 and the spider 12. Also, the bearing unit 13 is engaged to the journal 17 to be tiltable relative to the journal 17, and the bearing unit 13 can thus change its tilt angle relative to the journal 17 during angular displacements between the housing 11 and the spider 12 and can move linearly simultaneously, enabling power transmission.

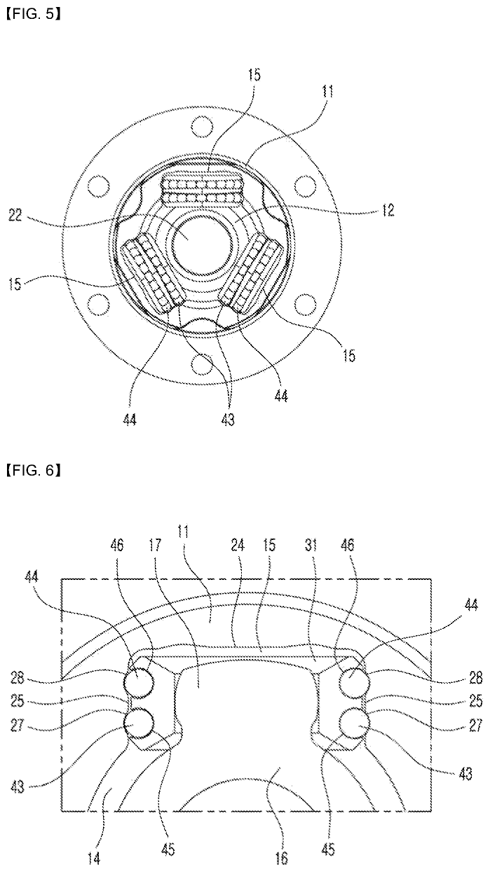

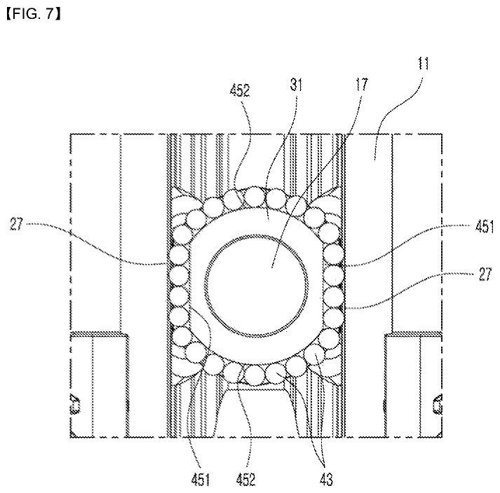

Referring to FIG. 4, the bearing unit 13 includes a track race 31 and ball arrays 41 and 42. The bearing unit 13 is positioned between the housing 11 and the spider 12, which are the power transmission components, playing functions as a bearing and serving as a medium for transmitting rotational power. On one hand, the bearing unit 13 is engaged to the journal 17 of the spider 12 to allow for relative movement of the spider 12 with respect to a longitudinal direction (radial direction in FIG. 2) of the journal 17 and tilting behavior, and on the other hand is designed to move linearly within the track groove 15 of the housing 11.

As shown in FIG. 4, the journal 17 may include a neck portion 18 connected to the hub 16 and a contact portion 19 that extends from a radial outer end of the neck portion 18. The contact portion 19 is the part that contacts the track race 31 and can be formed with an approximately convex curved surface. Specifically, the contact portion 19 can be formed as a spherical surface. Meanwhile, as shown in FIG. 4, the track race 31 may have a ring shape that surrounds the contact portion 19. The track race 31 may be equipped with a cylindrical through hole 32, within which the contact portion 19 of the journal 17 is be placed. By having the spherical contact portion 19 touch the inner surface of the cylindrical track race 31, relative tilting movement between the journal 17 and the track race 31 is enabled. The track race 31 is disposed in the track groove 15 of the housing 11 in a state of being engaged to the journal 17 of the spider 12 in a tiltable manner.

The first and second ball arrays 41 and 42 respectively include a plurality of first and second balls 43 and 44. As shown in FIG. 2, the two ball arrays 41 and 42 are positioned at different locations along a radial direction of the joint, i.e., along a length direction of the journal 17. That is, referring to FIG. 4, the ball array indicated by reference numeral 41 is positioned closer to the center of the joint than the ball array indicated by reference numeral 42. Redundant descriptions regarding the first ball array 41 and the second ball array 42 are omitted.

Referring to FIG. 6, the track groove 15 of the housing 11 forms a ceiling surface 24, and power transmission surfaces 25 that are disposed at both sides of the ceiling surface 24 to face each other in a circumferential direction. Referring to FIG. 8, the track race 31 is configured such that both portions among a peripheral surface 33 of the track race 31 that are positioned at circumferential direction of the joint face the power transmission surface 25 of the track groove 15 respectively. The balls 43 and 44 are positioned between the peripheral surface 33 of the track race 31 and the power transmission surface 25 of the track groove 15, acting as medium for power transmission.

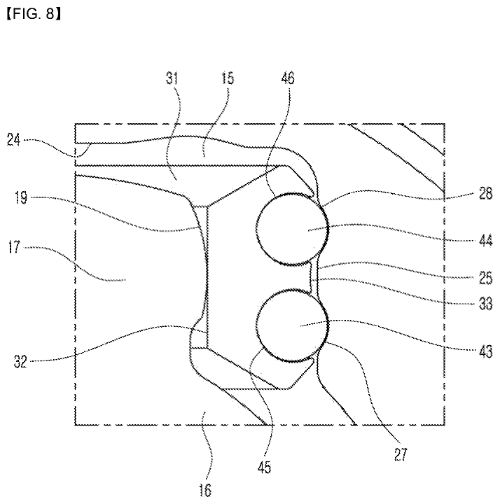

The first and second balls 43 and 44 are configured to circulate around the perimeter of the track race 31 during the operation of the joint. For instance, depending on the rotation direction and articulation angle of the housing 11 and spider 12, the first ball 43 can repeatedly rotate in a clockwise direction and in a counterclockwise direction, as shown in FIG. 7.

Referring to FIG. 4, the track race 31 forms inner ball grooves 45 and 46 for guiding the movement of the first and second balls 43 and 44, respectively, and the ball grooves 45 and 46 form circulation paths for the balls 43 and 44. The ball grooves 45 and 46 may be formed so that they run around the periphery of the track race 31 on the peripheral surface 33 of the track race 31, thus creating the circulation paths for the balls in a circumferential direction. As shown in FIGS. 6 and 8, the balls 43 and 44 are accommodated in the ball grooves 45 and 46 in such a way that portions thereof protrude outward from the ball grooves 45 and 46. In this connection, at least portions of the protruded portions of the balls 43 and 44 are accommodated in the outer ball grooves 27 and 28 formed on the power transmission surface 25 of the track groove 15. Thus, the movements of the balls 43 and 44 are guided while they are partially accommodated in both the ball grooves 45 and 46 of the track race 31 and the ball grooves 27 and 28 of the track groove 15.

By positioning two ball arrays 41 and 42 at different locations along the longitudinal direction of the journal 17 of the spider 12, each ball 43 and 44 of the ball arrays 41 and 42 contact the power transmission surface 25 of the housing 11 from different positions along the length of the journal 17. Compared to configurations where a single ball array creates a contact point or a cylindrical roller forms a broad contact area, this embodiment of the invention having two ball arrays can enlarge the contact area (the area between the two contact points) in a radial direction without significantly increasing the overall size of the constant velocity joint. This can reduce wobbling of the track race during joint operation and consequently improve GAF characteristics.

The ball grooves 45 and 46 comprises a pair of grooves 451 and 461 arranged to face each other in a circumferential direction of the joint and a pair of grooves 452 and 462 arranged to face each other in a longitudinal direction of the joint. The grooves 451 and 461 that are arranged to face each other in the circumferential direction of the joint are extended linearly and work in conjunction with the ball grooves 27 and 28 of the housing to guide the movement of the balls 43 and 44 involved in power transmission. The grooves 452 and 462 that are arranged to face each other in the longitudinal direction of the joint are extended in a curve to connect the grooves 451 and 461 facing each other in the circumferential direction, each independently forming a portion of the ball circulation path.

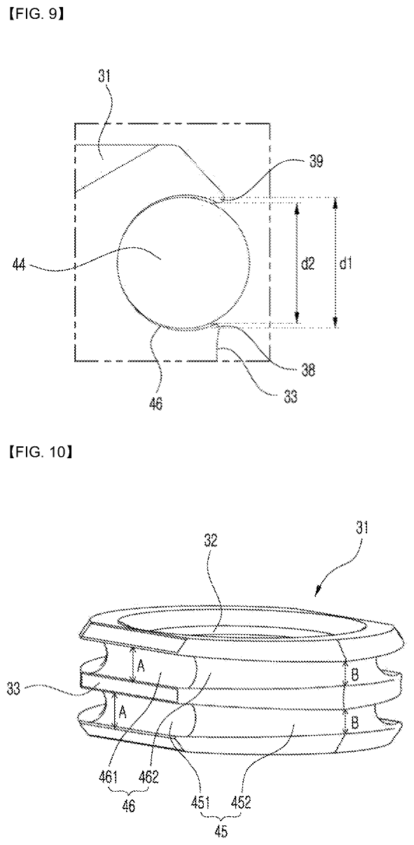

Referring to FIG. 9, the height d2 of the opening of the ball groove 46 formed on the peripheral surface 33 of the track race 31 is designed to be smaller than the diameter d1 of the ball 44 accommodated in the ball groove 46. This prevents the ball 44 from escaping from the ball groove 46. The ball 44 may have a spherical shape, and the ball groove 46 may have a cylindrical shape with a circular cross-section that has a diameter larger than that of the ball 44. At this point, by placing the center of the circle forming the cross-section of the ball groove 46 more inward (to the left in FIG. 9) than the opening, the height d2 of the opening of the ball groove 46 can be formed smaller than the diameter d1 of the ball 44 accommodated therein. As a result, as illustrated in FIG. 9, the opening of the ball groove 46 is formed by end portions 38 and 39 in a narrowed shape of converging toward each other. For example, the track race 31 may be made of metal, and the tapered end portions 38 and 39 of the track race 31 may be formed by plastically deforming a flat portion through machining, pressing, rolling processes or the like.

The cross-section of the ball grooves 45 and 46 of a cylindrical shape has a shape of a circle with a portion removed, and a diameter of a circle forming the cross-section of the ball grooves 45 and 46 is greater than the diameter of the balls 43 and 44. As a result, each ball 43 and 44 contacts the track race 31 at a single point. This allows for stable torque transmission with minimal friction. Furthermore, the ball grooves 27 and 28 of the housing 11 also have a cross-section in the shape of a circle with a portion removed, and the diameter of the circle forming the cross-section of the ball grooves 27 and 28 is formed greater than the diameter of the balls 43 and 44. As a result, each ball 43 and 44 contacts the housing 11 at a single point. Meanwhile, in another embodiment of the present invention, the ball and track race, as well as the ball and the housing, may be configured to contact at two or more points.

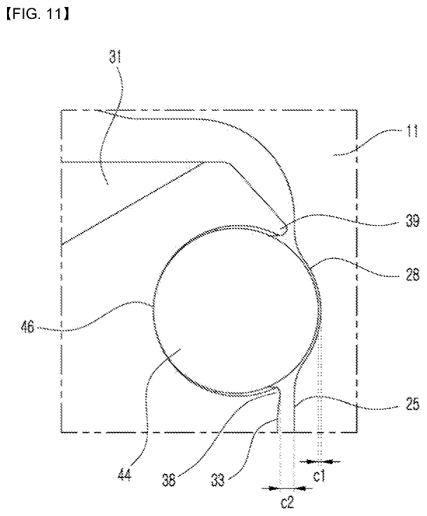

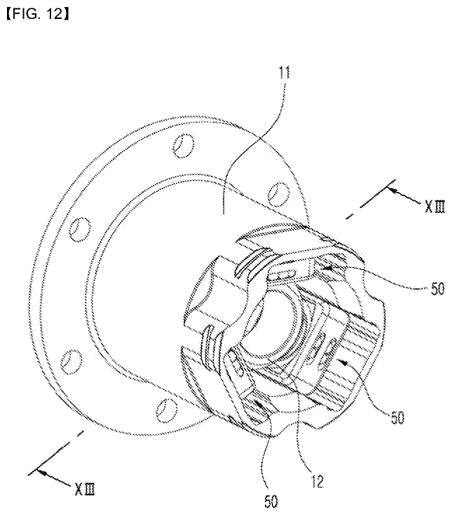

When the balls 43 and 44 circulate through the grooves 451 and 461 forming a straight section and the grooves 461 and 462 forming a curved section, forces act on the cycling balls 43 and 44 that urges them out of the grooves 451, 452, 461, and 462. The force urging the balls 43 and 44 out is especially great in the grooves 452 and 462 forming the curved section. Considering this, in an embodiment of the present invention, the opening height of the grooves 452 and 462 in the curved section is formed relatively smaller. Referring to FIG. 10, the height B the opening of the grooves 452 and 462 forming the curved section is smaller than the height A of the opening of the grooves 451 and 461 forming the straight section. As a result, the balls 43 and 44 can be effectively prevented from moving out in the grooves 452 and 462 forming the curved section where the force pushing them out is relatively larger.

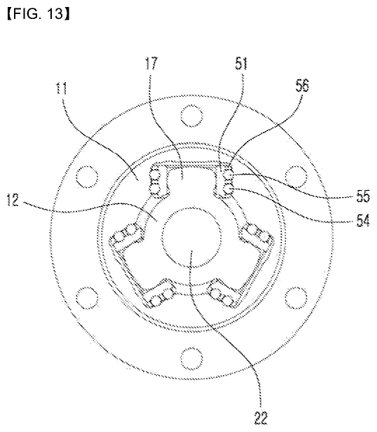

According to an embodiment of the present invention, in order to prevent the peripheral surface 33 of the track race 31 from directly striking the power transmission surface 25 of the housing 11 during the operation of the joint, as shown in FIG. 11, the clearance c2 between the peripheral surface 33 of the track race 31 and the power transmission surface 25 of the housing 11 is formed greater than the clearance c1 between the ball 44 and the ball groove 28 of the housing 11. Here, ‘clearance’ refers to the minimum separation distance between two components in a direction perpendicular to the longitudinal direction of the journal 17, i.e., the radial direction of the joint. As a result, during the joint operation, when the track race 31 and the balls 43 and 44 approach the power transmission surface 25 of the housing 11 due to the relative motion between the housing 11 and the track race 31, the balls 43 and 44 first come into contact with the bottom surface of the ball grooves 27 and 28 of the housing 11, and thus this prevents the track race 31 from striking the power transmission surface 25 of the housing 11.

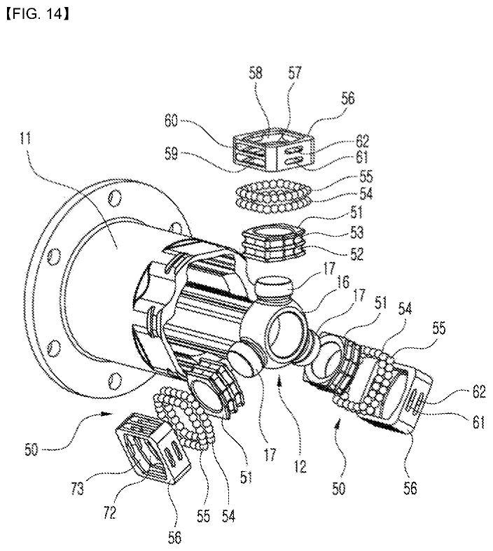

Referring now to FIG. 12 to FIG. 17, a tripod constant velocity joint according to another embodiment of the present invention will be described. For parts that are the same as those described in the above embodiment, the same reference numerals are used and redundant descriptions are omitted.

Referring to FIG. 12 to FIG. 14, the tripod constant velocity joint comprises a housing 11, a spider 12, and a bearing unit 50. Three bearing units 50 are respectively engaged to three journals 17 of the spider 12. The overall function of the bearing unit 50 is the same as that described in the aforementioned embodiment.

The bearing unit 50 comprises a track race 51, a ball array including a plurality of balls 54 and 55, and a retainer 56. The track race 51 has inner ball grooves 52 and 53 for accommodating respectively the balls 54 and 55 of the ball array. The ball grooves 52 and 53 are designed to form a ball circulation path along the periphery of the track race 51 so that the balls 54 and 55 can circulate. These features are the same as described in the previous example, so detailed explanations are omitted.

The retainer 56 is configured to surround the track race 51 to prevent the balls 54 and 55 from escaping. The retainer 56 may have a ring shape to be able to surround the track race 51.

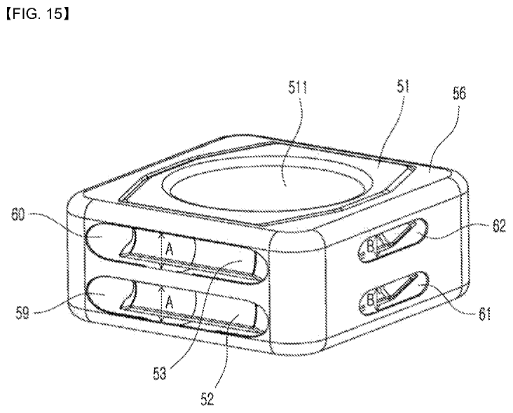

The retainer 56, as shown in FIG. 14, is provided with ball grooves 72 and 73 formed on an inner circumference therefore corresponding to the ball grooves 52 and 53 formed on the peripheral surface of the track race 51, and the balls 54 and 55 are accommodated in a manner of being able to circulate within the space formed by the ball grooves 52 and 53 of the track race 51 and the corresponding ball grooves 72 and 73 of the retainer 56.

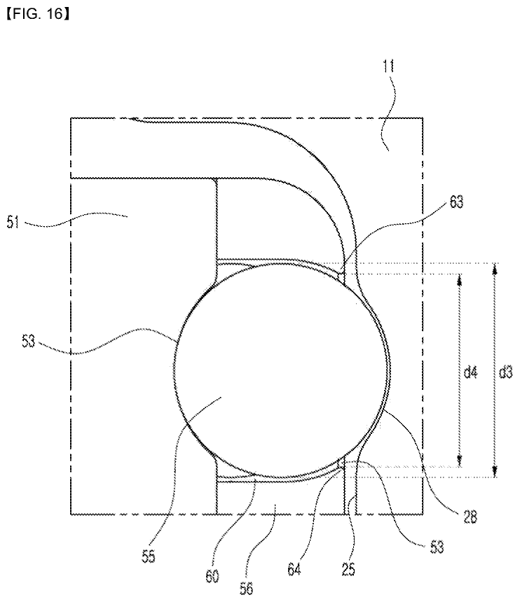

The retainer 56 includes windows 59 and 60 formed on a portion facing the power transmission surface 25 of the housing 11. Each window 59 and 60 is configured to expose the outer part of the ball 54 and 55. The outer parts of the ball exposed through windows 59 and 60 are inserted into the ball grooves 27 and 28 of the housing 11. Meanwhile, as shown in FIGS. 14 and 15, the retainer 56 includes windows 61 and 62 formed on a surface provided at a position perpendicular to a part facing the power transmission surface 25 of the housing 11. The outer parts of the balls 54 and 55 are exposed to the outside of the retainer 56 through windows 61 and 62. By the parts of the ball 54 and 55 exposed through windows 61 and 62, the retainer 56 can be prevented from being damaged when the bearing unit 13 collides with the housing 11 while the half shaft including the tripod constant velocity joint is mounted on a vehicle.

The retainer 56 is configured to prevent the balls 54 and 55 from escaping. Referring to FIG. 16, the retainer 56 is formed such that the height d4 of the window 53 formed on a portion facing the power transmission surface 25 of the housing 11 is smaller than the diameter d3 of the ball 55. This ensures that the ball 55 cannot escape the retainer 56 through the window 53.

The retainer 56 may have parts 63 and 64 that converge towards each other in the section forming the window 53. Furthermore, it is configured that the height B of the windows 61 and 62 formed on a position perpendicular to the part facing the power transmission surface 25 of the housing 11 is smaller than the height A of the windows 52 and 53 formed on a portion facing the power transmission surface 25 of the housing 11. By making the height B of the windows 61 and 62 formed in areas where the force escaping the balls 54 and 55 becomes high smaller, it is possible to effectively prevent balls from escaping in curved sections of the ball circulation path.

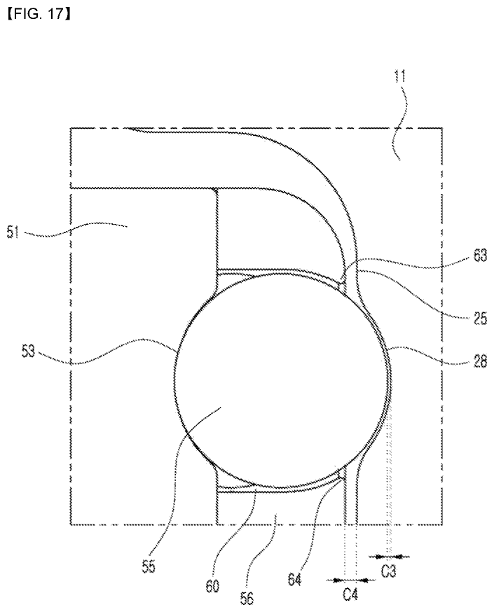

In an embodiment of the present invention, to prevent the retainer 56 from directly colliding with the power transmission surface 25 of the housing 11 during joint operation, as illustrated in FIG. 17, a clearance c4 between the peripheral surface of the retainer 56 and the power transmission surface 25 of the housing 11 is configured to be greater than a clearance c3 between the ball 55 and the ball groove 28 of the housing 11. As a result, when the retainer 56 and the balls 54 and 55 approach the power transmission surface 25 of the housing 11 due to relative movement between the housing 11 and the retainer 56 during joint operation, the balls 54 and 55 will first touch the bottom surface of the ball grooves 27 and 28 of the housing 11, and thus the retainer 56 is prevented from colliding with the power transmission surface 25 of the housing 11.

The embodiments of the invention have been described above, but the scope of the rights of the invention is not limited thereto. It includes all changes and modifications that are easily made by a person with ordinary knowledge in the technical field to which the invention belongs and are recognized as equivalent.

### INDUSTRIAL APPLICABILITY

The present invention can be applied to the manufacturing method of a constant velocity joint, such as a tripod, of a vehicle, indicating its industrial applicability.

1. A tripod constant velocity joint comprising:
a housing having a tubular shape that forms three track grooves arranged along a circumferential direction;
a spider having a hub placed inside the housing and three journals respectively extending radially outward from the hub and respectively arranged in the track grooves; and
three bearing units respectively engaged to the journals,
wherein each of the bearing units comprises a track race that is arranged in the track groove in a state of being tiltably engaged to the journal and a first and a second ball array that are disposed between a peripheral surface of the track race and power transmission surfaces facing each other in a circumferential direction to form the track grooves and respectively comprise a plurality of balls, and
wherein the first and second ball arrays are arranged at different positions along a length direction of the journal.

2. The tripod constant velocity joint of claim 1, wherein the track race comprises a first and a second inner ball groove configured to partially accommodate the first and second ball arrays, respectively, and
wherein the first and second inner ball grooves respectively form a ball circulation path that allows the balls of the first and second ball arrays to circulate along a periphery of the track race.

3. The tripod constant velocity joint of claim 2, wherein heights of openings of the first and second inner ball grooves are smaller than a diameter of the ball.

4. The tripod constant velocity joint of claim 2, wherein the first and second inner ball grooves comprise a straight section provided on a portion facing the power transmission surface, and a curved section connecting the linear section, and
wherein the power transmission surface of the housing is provided with a first and a second outer ball grooves formed at positions corresponding to the straight sections of the first and second inner ball grooves.

5. The tripod constant velocity joint of claim 4, wherein a height of the opening of the curved section of the first and second inner ball grooves is smaller than a height of an opening of the straight section.

6. The tripod constant velocity joint of claim 1, wherein the track race comprises a first and a second inner ball groove configured to partially accommodate the first and second ball arrays respectively, and
wherein the housing comprises a first and second outer ball grooves, respectively formed on the power transfer surface at positions corresponding to the first and second inner ball grooves, to accommodate parts of the balls of the first and second ball arrays that are exposed outside the first and second inner ball grooves.

7. The tripod constant velocity joint of claim 6, wherein the balls of the first and second ball arrays are configured to contact at one or more points with the first and second inner ball grooves and the first and second outer ball grooves, respectively.

8. The tripod constant velocity joint of claim 6, wherein a clearance between a peripheral surface of the track race and the power transfer surface is greater than a clearance between the balls of the first and second ball arrays and the first and second outer ball grooves.

9. The tripod constant velocity joint of claim 1, wherein the bearing unit further comprises a retainer configured to surround the track race and accommodates the first and second ball arrays.

10. The tripod constant velocity joint of claim 9, wherein the retainer is provided with a first and a second window that are respectively formed on a part facing the power transmission surface, to expose outer part of a portion of balls of the first and second ball arrays.

11. The tripod constant velocity joint of claim 10, wherein a height of the first and second windows is smaller than a diameter of the balls of the first and second ball arrays.

12. The tripod constant velocity joint of claim 10, wherein the first and second inner grooves extend along a peripheral surface of the track race to form circulation paths in which the balls of the first and second ball arrays can circulate, and
wherein the retainer further comprises a third and a fourth window formed at portions perpendicular to parts facing the power transmission surface, to expose outer parts of a portion of the balls of the first and second ball arrays.

13. The tripod constant velocity joint of claim 12, wherein heights of the third and fourth windows are smaller than heights of the first and second windows.

14. The tripod constant velocity joint of claim 9, wherein the track race comprises a first and a second inner ball groove formed to partially accommodate the first and second ball arrays, respectively,
wherein the retainer has a first and a second window that are respectively formed on a portion facing the power transfer surface to allow outer portions of a portion of the balls of the first and second ball arrays to be exposed, and
wherein the housing comprises a first and a second outer ball grooves that are respectively formed on the power transfer surface at positions corresponding to the first and second inner ball grooves, to accommodate the exposed portions of the balls of the first and second ball arrays.

15. The tripod constant velocity joint of claim 14, wherein a clearance between the retainer and the power transfer surface is greater than a clearance between the balls of the first and second ball arrays and the first and second outer ball grooves.

16. A tripod constant velocity joint comprising:
a housing having a tubular shape that forms three track grooves arranged along a circumferential direction;
a spider having a hub placed inside the housing and three journals respectively extending radially outward from the hub and respectively arranged in the track grooves; and
three bearing units respectively engaged to the journals,
wherein each of the bearing units comprises:
a track race that is arranged in the track groove in a state of being tiltably engaged to the journal; and
a first and a second ball array that are disposed between a peripheral surface of the track race and power transmission surfaces facing each other in a circumferential direction to form the track grooves and respectively comprise a plurality of balls,
wherein the first and second ball arrays are arranged in different positions along a longitudinal direction of the journal,
wherein the track race comprises a first and a second inner ball groove that are respectively configured to partially accommodate the first and second ball arrays,
wherein the housing comprises a first and a second outer ball groove that are respectively formed on the power transmission surface to correspond to the first and second inner ball grooves, and
wherein heights of openings of the first and second inner grooves are smaller than a diameter of the balls of the first and second ball arrays.

17. The tripod constant velocity joint of claim 16, wherein a clearance between a peripheral surface of the track race and the power transfer surface is greater than a clearance between the balls of the first and second ball arrays and the first and second outer ball grooves.

18. The tripod constant velocity joint of claim 16, wherein the first and second inner ball grooves respectively comprise a pair of straight sections respectively facing the power transfer surfaces that face each other and curved sections connecting the pair of straight sections; and
wherein a height of openings of the first and second inner ball grooves in the curved sections is smaller than a heigh of openings of the first and second inner ball grooves in the straight section.

19. The tripod constant velocity joint of claim 16, wherein the balls of the first and second ball arrays are configured to contact at one or more points with the first and second inner ball grooves and the first and second outer ball grooves, respectively.

20. A tripod constant velocity joint comprising:
a housing having a tubular shape that forms three track grooves arranged along a circumferential direction;
a spider having a hub placed inside the housing and three journals respectively extending radially outward from the hub and respectively arranged in the track grooves; and
three bearing units respectively engaged to the journals,
wherein each of the bearing units comprises:
a track race that is arranged in the track groove in a state of being tiltably engaged to the journal;
a first and a second ball array that are disposed between a peripheral surface of the track race and power transmission surfaces facing each other in a circumferential direction to form the track grooves and respectively comprise a plurality of balls; and
a retainer configured to surround the track race and accommodates the first and second ball arrays,
wherein the first and second ball arrays are arranged at different positions along a longitudinal direction of the journal,
wherein the track race comprises a first and a second inner ball groove that are configured to partially accommodate the first and second ball arrays, respectively,
wherein the housing comprises a first and a second outer ball groove that are respectively formed on the power transmission surface to correspond to the first and second inner ball grooves,
wherein the retainer is provided with a first and a second window that are respectively formed on a part facing the power transmission surface to allow outer portions of a portion of the balls of the first and second ball arrays to be exposed, and
wherein heights of the first and second windows are smaller than a diameter of the balls of the first and second ball arrays.

21. The tripod constant velocity joint of claim 20, wherein a clearance between the retainer and the power transfer surface is greater than a clearance between the balls of the first and second ball arrays and the first and second outer ball grooves.

22. The tripod constant velocity joint of claim 20, wherein the first and second inner grooves extend along a peripheral surface of the track race to form circulation paths in which the balls of the first and second ball arrays can circulate,
wherein the retainer further comprises a third and a fourth window formed at portions perpendicular to parts facing the power transmission surface, to expose outer parts of a portion of the balls of the first and second ball arrays, and
wherein heights of the third and fourth windows are smaller than heights of the first and second windows.

23. The tripod constant velocity joint of claim 20, wherein the balls of the first and second ball arrays are configured to contact at one or more points with the first and second inner ball grooves and the first and second outer ball grooves, respectively.
